(19) United States
(12) Patent Application Publication
(10) Pub. No.: US 2006/0216477 A1
(43) Pub. Date: Sep. 28, 2006

(54) Micro-reflecting structure

(75) Inventors: Chien-Chiu Peng, Ping Chen (TW); Hsin-Hsing Li, Ping Chen (TW); Hong-Chun Hsieh, Ping Chen (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Ping Chen (TW)

(21) Appl. No.: 11/318,992

(22) Filed: Dec. 27, 2005

(30) Foreign Application Priority Data
Mar. 25, 2005 (TW) 094109441

(51) Int. Cl. B32B 5/16

(52) U.S. Cl. 428/143; 428/323

(57) ABSTRACT

A micro-reflecting layer of the present invention used for polarized plates and display device comprises a transparent resin layer and a plurality of micro-reflecting particles. The micro-reflecting particles are uniformly implanted into the transparent resin, and light from an external source partially passes through the micro-reflecting particles and partially is reflected by the micro-reflecting particles to display an image. Furthermore, a plurality of optical diffusing particles is also added into the micro-reflecting layer so as to uniformly diffuse the light in the micro-reflecting layer.

### BACKGROUND OF THE INVENTION

1. Field of the Invention

The present invention relates to a micro-reflecting layer, and more particularly to a micro-reflecting layer used for polarized plates and display devices with effective reflection of an external light source due to a reflective index increasing of the micro-reflecting layer.

2. Description of the Prior Art

A display device is an important tool in modem society and instant display devices combined with personal communication equipment are now deemed essential possessions. The electronic devices, such as cell phones, personal digital assistants, digital cameras and global positioning systems (GPS), are created, and various functions of the electronic devices are continuously developed with the advance of technology.

For small size electronic devices with multiple functions, such as cell phones combined with digital cameras and multimedia, the key challenge and technique is how to effectively save electricity or power.

Generally, a traditional cell phone includes a power-on mode and a power-off mode. In the power-on mode, an internal battery supplies power to backlight elements, and the backlight elements can emit light penetrating a liquid crystal panel and polarized plates to show an image on a screen of the cell phone. In the power-off mode, no images or pictures are shown because no power is provided to the backlight elements. However, the only two operating modes cannot effectively save power.

Another new kind of cell phone further has a standby mode. If the cell phone does not work for a period of time, the operating system therein shifts to a standby mode. In this mode, the cell phone only utilizes external light from environment being reflected by some special elements in the cell phone to display simple information, such as time, or date, etc., on a screen without driving backlight elements to emit light for display,. However, how to effectively increase the amount of reflective light has confused researchers and designers, and it is a very important and essential problem to solve nowadays.

### SUMMARY OF THE INVENTION

According to the primary object of the present invention, a micro-reflecting layer for effective reflection of an external light source is provided, thereby reducing consumption of electricity.

In another object of the present invention, a polarized plate and a display device both comprising a micro-reflecting layer for effective reflection of an external light source is provided, thereby raising the luminosity thereof.

Accordingly, the present invention is related to a micro-reflecting layer used for polarized a plate and a display device, more particularly to a compact display device such as a cell phone, a digital camera, a personal assistant, and a global positioning system.

To attain the above objects, the micro-reflecting layer includes a transparent resin layer and a plurality of micro-reflecting particles. With uniform mixing of a plurality of micro-reflecting particles in the transparent resin layer, light from an external source partially passes through the micro-reflecting particles and penetrates the transparent resin, and partially is reflected by the micro-reflecting particles. Furthermore, a plurality of optical diffusing particles is optionally added into the micro-reflecting layer for uniformly diffusing light. With the property of light partially-passing and partially-reflected by the micro-reflecting layer, texts and images shown on a screen by reflective light from the external source are attained, and the objective of reducing consumption of electricity is achieved.

The objects, features, and effects of the present invention will be more readily understood from the following detailed description of the preferred embodiment with the appended drawings.

### BRIEF DESCRIPTION OF THE DRAWINGS

FIG. 1 is a schematic view showing a micro-reflecting layer coated on a substrate according to the present invention;

FIG. 2 is a schematic view showing a light passage in the micro-reflecting layer of FIG. 1;

FIG. 3 is another embodiment of a schematic view showing the micro-reflecting layer coated on a substrate according to the present invention;

FIG. 4 is a schematic view showing a light passage in the micro-reflecting layer of FIG. 3;

FIG. 5 is a schematic view showing a micro-reflecting film applied to a polarized plate;

FIG. 6 is a schematic view showing a light passage in the polarized plate of FIG. 5;

FIG. 7 is a schematic view showing a micro-reflecting polarized plate applied to a display device;

FIG. 8a is a schematic view showing a display device with light from an external source; and

FIG. 8b is a schematic view showing a display device with a backlight source for showing pictures.

### DETAILED DESCRIPTION OF THE PREFERRED EMBODIMENT

The present invention will be explained below in conjunction with embodiments.

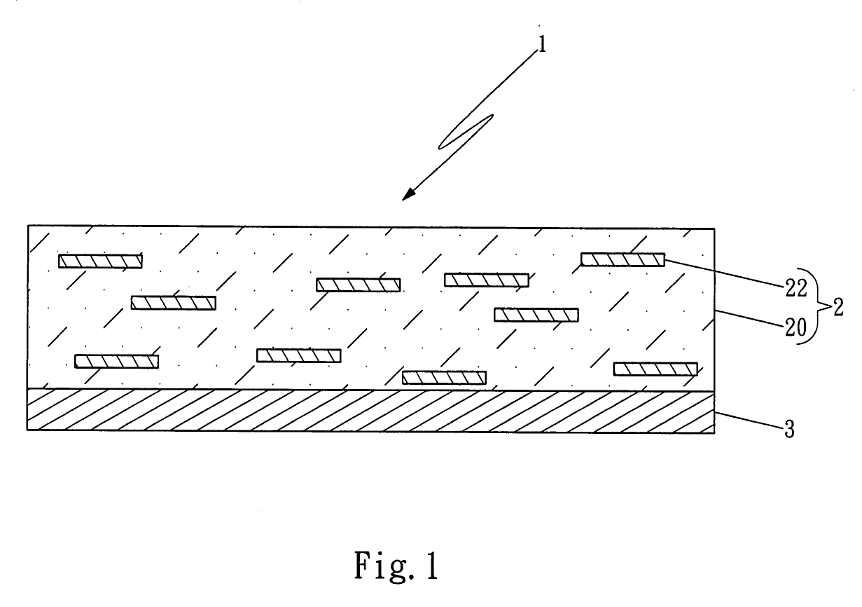

Referring to FIG. 1, it is a schematic view showing a micro-reflecting layer 2 coated on a substrate according to the present invention. The micro-reflecting layer 2 of FIG. 1 is applied to a polarized plate and a display device, particularly to a compact display device such as a cell phone, a digital camera, a personal digital assistant or a global positioning system. The micro-reflecting layer 2 includes a transparent resin layer 20 and a plurality of micro-reflecting particles 22. Usually, the micro-reflecting layer 2 is coated on one surface of the transparent substrate 3 to form a micro-reflecting film 1. The transparent resin layer 20 is formed of transparent resin with a refractive index between 1.3 and 1.6 to allow light passing through. According to this embodiment, the transparent resin is acrylic resin.

A plurality of micro-reflecting particles 22 is uniformly implanted into the transparent resin layer 20. The micro-reflecting particles 22 have the property of light partially-passing and partially-reflected with a refractive index between 1.3 and 1.6, and an average radius of size between 1 μm to 50 μm. It is preferably that the micro-reflecting particles 22 are selected from Aluminum oxide (A12O3), Titanium dioxide (TiO2) or Silicon dioxide (SiO2), and the weight percentage of the plurality of micro-particles 22 in the transparent resin layer 20 ranges between 1% and 20%.

The transparent substrate 3 is selected from Polyethylene terephthalate (PET), Triacetyl cellulose (TAC), Triacetyl cellulose (TAC), Polycarbonate (PC) or other transparent materials according to the present invention. The thickness of the micro-reflecting film 1 between 50 μm and 100 μm is preferred to utilize.

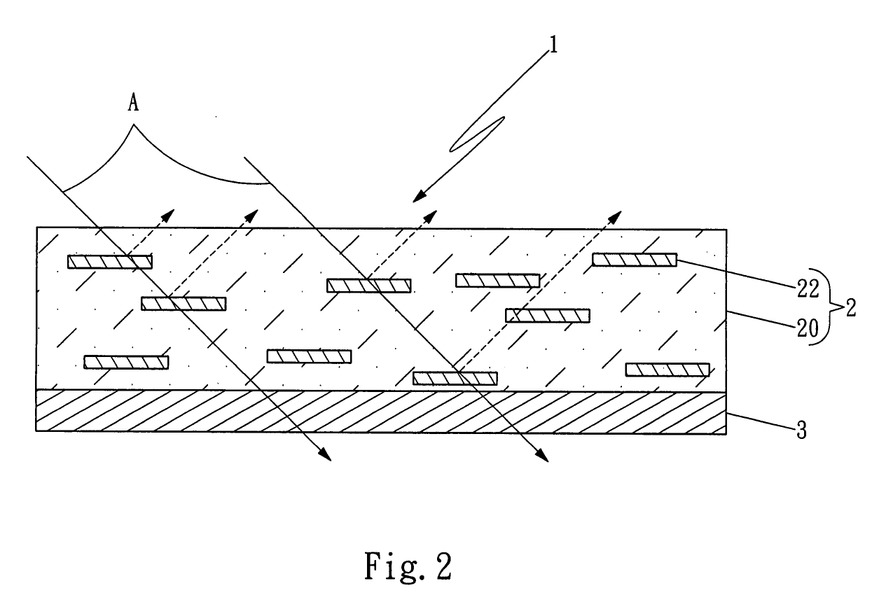

Referring to FIG. 2, it is a schematic view showing that light from an external source partially passes through the micro-reflecting film 1 and partially is reflected by the micro-reflecting particles 22.

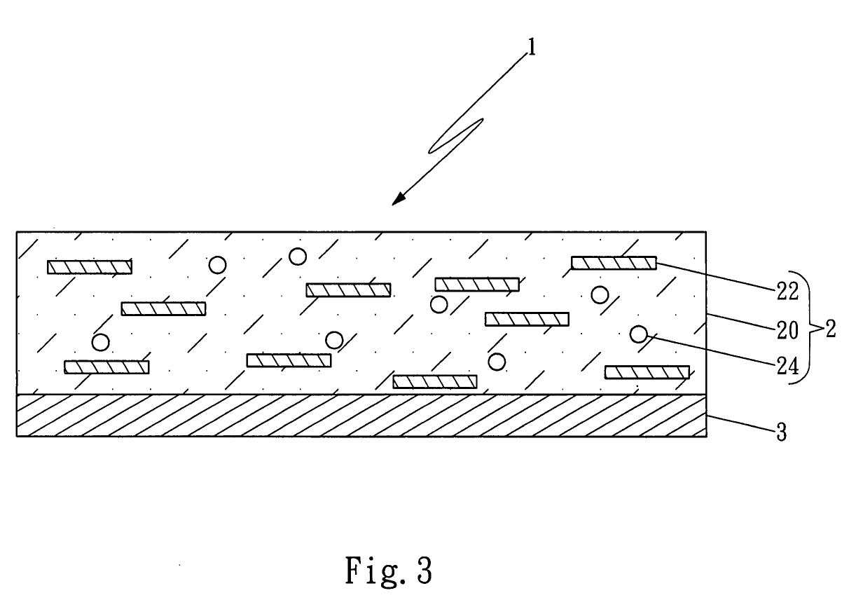

Referring to FIG. 3, the micro-reflecting layer 2 coated on the transparent substrate 3 further includes a plurality of optical diffusing particles 24 in the micro-reflecting layer 2. The optical diffusing particles 24 are uniformly distributed in the micro-reflecting layer 2 to uniformly diffuse light from the external source. The optical diffusing particles 24 with an average radius of size between 1 μm to 50 μm are selected from Titanium dioxide (TiO2), Silicon dioxide (SiO2), or silica. The weight percentage of the micro-reflecting particles 22 and the optical diffusing particles 24 in the transparent resin layer 20 ranges between 1%˜20%.

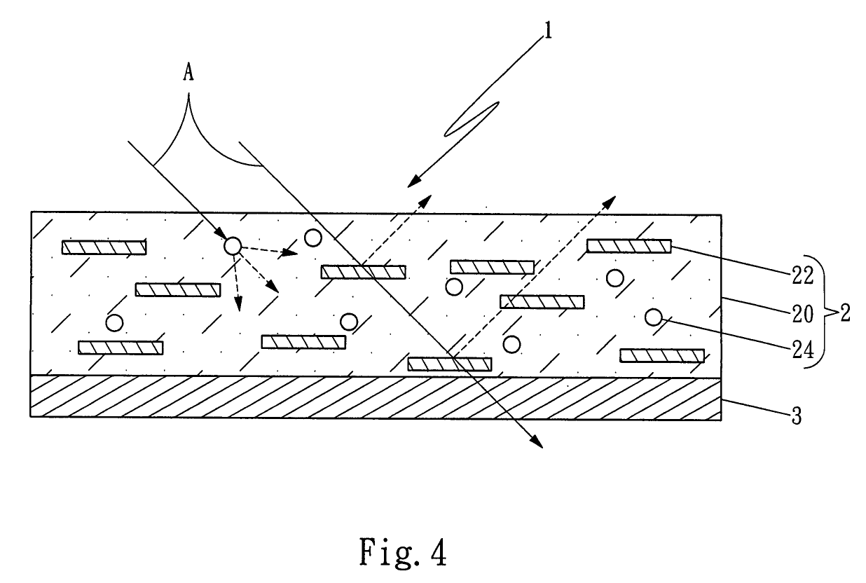

Referring to FIG. 4, as light from the external source travels into the micro-reflecting layer 2, the light is partially reflected by the micro-reflecting particles 22 and partially passes through the micro-reflecting film 1. Furthermore, during traveling in the micro-reflecting layer 2, as the light passes through the optical diffusing particles 24, the light is uniformly diffused in the micro-reflecting layer 2.

Experimentally, if the micro-reflected particles 22 and the optical diffusing particles 24 are not added into the micro-reflecting layer 2, the amount of reflective light from the external source is about 9%. After the micro-reflected particles 22 and the optical diffusing particles 24 are added into the micro-reflecting layer 2, the amount of reflective light from the external source is obviously increased up to 30%˜40%.

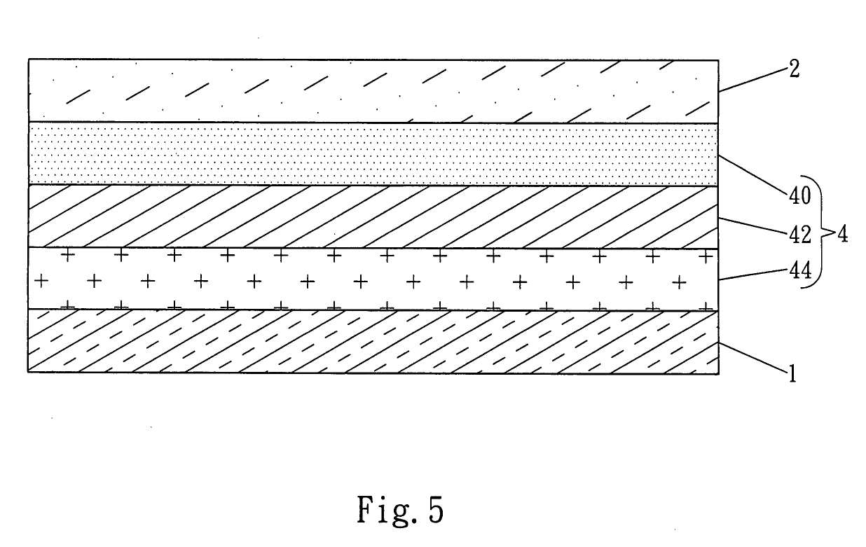

Referring to FIG. 5, it is a schematic view showing a micro-reflecting film 1 and a micro-reflecting layer 2 applied to a polarized plate. The polarized plate 4 includes a polarized film 40, a diffusing adhesive film 42, and an optical brightness enhancement film 44. An upper surface of the polarized film 40 is attached to the micro-reflecting layer 2 and a lower surface of the polarized film 40 is attached to an upper surface of the diffusing adhesive film 42. A lower surface of the diffusing adhesive film 42 is attached to an upper surface of the optical brightness enhancement film 44, and a lower surface of the optical brightness enhancement film 44 is attached to the micro-reflecting film 1.

Specifically, the polarized film 40 is formed of a polarized element, such as Polyvinylalcohol (PV) sandwiched by two protective films, such as Triacetyl cellulose (TAC), respectively. The diffusing adhesive film 42 is formed by mixing optically diffusible particles and acrylic resin. The optical brightness enhancement film 44 is formed of several layers with different refractive indexes.

Preferably, the thickness of the micro-reflecting layer 2 ranges between 10 and 30 μm; the thickness of the polarized film 40 ranges between 95 μm and 115 μm; the thickness of the diffusing adhesive film 42 ranges between 15 μm and 35 μm; the thickness of the optical brightness enhancement film 44 ranges between 100 μm and 120 μm; and the thickness of the micro-reflecting film 1 ranges between 50 μm and 100 μm. The micro-reflecting film 1 is formed of the micro-reflecting layer 2 and a transparent substrate 3 as in FIG. 1 and FIG. 3. The micro-reflecting layer 2 includes a transparent resin layer 20 and a plurality of micro-reflecting particles 22. The transparent resin layer 20 is formed of transparent resin with a refractive index between 1.3 and 1.6, and comprises acrylic resin in this embodiment. The micro-reflecting particles 22 are uniformly implanted into the transparent resin layer 20 with a refractive index between 1.3 and 1.6 and an average radius of size between 1 μm and 50 μm, and are selected from Aluminum oxide (A1₂O₃), Titanium dioxide (TiO₂), or Silicon dioxide (SiO₂). The weight percentage of micro-reflecting particles 22 in the transparent resin 20 ranges between 1% and 20%. Moreover, a plurality of optical diffusion particles 24 is also can be added into the transparent resin layer 20, so light from an external source can be more uniformly diffused therein. The optical diffusing particles 24 with an average radius of size between 1 μm and 50 μm are selected from Titanium dioxide (TiO₂), Silicon dioxide (SiO₂), or silica. The weight percentage of the micro-reflecting particles 22 and the optical diffusion particles 24 in the transparent resin layer 20 ranges between 1% to 20%. The transparent substrate 3 is selected from Polyethylene terephthalate (PET), Triacetyl cellulose (TAC), Polycarbonate (PC) or other transparent materials. The thickness of the micro-reflecting film 1 formed of the micro-reflecting layer 2 and the transparent substrate 3 ranges between 50 μm to 100 μm.

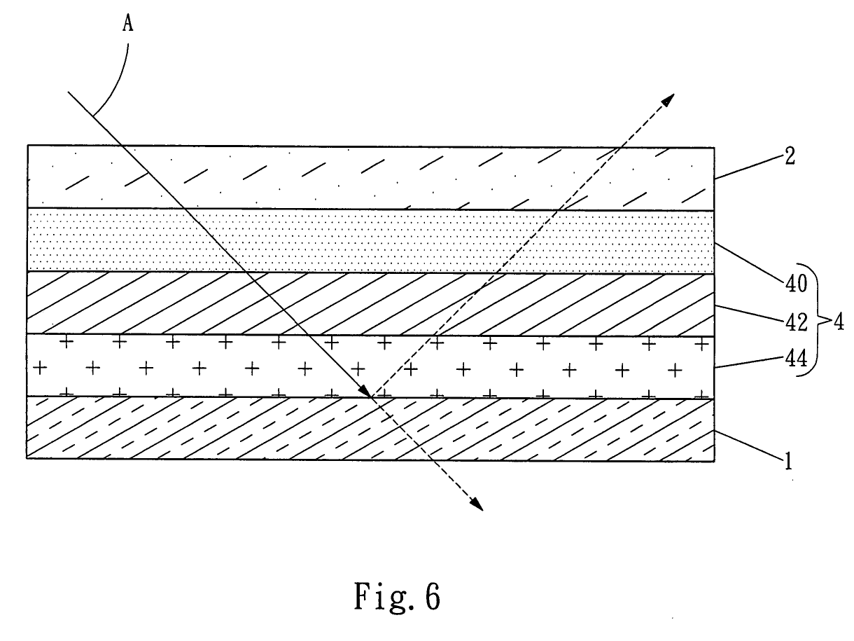

Referring to FIG. 6, as light passes the polarized plate 4, light is partially reflected and partially passes through the polarized plate 4, whereby the micro-reflecting effect is achieved. Experimentally, the amount of reflective light by traditional polarized plate is about 8%, but the amount of reflective light by the polarized plate 4 of present invention is raised to 15%˜20%. Obviously, the reflective index is raised and brightness is also increased.

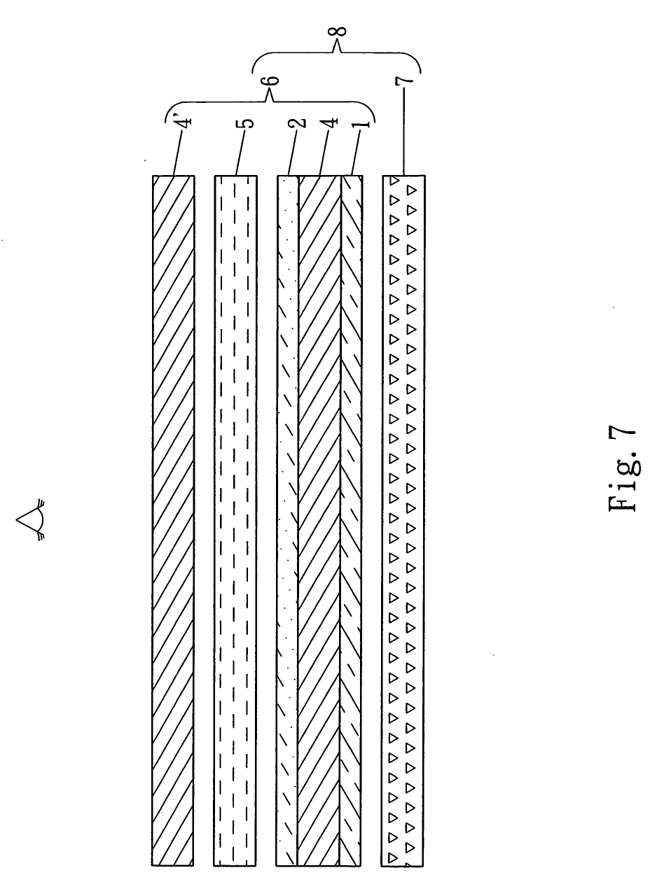

Referring to FIG. 7, it is a schematic view showing a micro-reflecting polarized plate applied to a display device. The display device 8 includes a liquid crystal panel 6 and a backlight module 7. The liquid crystal panel 6 includes an upper polarized panel 4′, a lower polarized panel 4 and a liquid crystal layer 5; wherein the liquid crystal layer 5 is set between the upper polarized panel 4′and the lower polarized panel 4. As shown in FIG. 5, the lower polarized panel 4 includes a polarized film 40, a diffusing adhesive film 42 and an optical brightness enhancement film 44, and the micro-reflecting film 1 and the micro-reflecting layer 2 are coated on opposite sides of the lower polarized panel 4 respectively. All of the micro-reflecting film 1, the micro-reflecting layer 2 and the lower polarized panel 4 are the same as the embodiment showed in the FIG. 5.

The micro-reflecting film 1 is formed of the micro-reflecting layer 2 and a transparent substrate 3 as in FIG. 1 and FIG. 3. The micro-reflecting layer 2 includes a transparent resin layer 20 and a plurality of micro-reflecting particles 22. The transparent resin layer 20 is formed of transparent resin with a refractive index between 1.3 and 1.6, and comprises acrylic resin in this embodiment. The micro-reflecting particles 22 are uniformly implanted into the transparent resin layer 20 with a refractive index between 1.3 and 1.6 and an average radius of size between 1μm and 50 μm, and are selected from Aluminum oxide (A1₂O₃), Titanium dioxide (TiO₂), or Silicon dioxide (SiO₂). The weight percentage of micro-reflecting particles 22 in the transparent resin 20 ranges between 1% and 20%. Moreover, a plurality of optical diffusion particles 24 is also can be added into the transparent resin layer 20, so light from an external source can be more uniformly diffused therein. The optical diffusing particles 24 with an average radius of size between 1μm and 50 μm are selected from Titanium dioxide (TiO₂), Silicon dioxide (SiO₂), or silica. The weight percentage of the micro-reflecting particles 22 and the optical diffusion particles 24 in the transparent resin layer 20 ranges between 1% to 20%.

The transparent substrate 3 is selected from polyethylene terephthalate (PET), triacetyl cellulose (TAC), polycarbonate (PC) or other transparent materials. The thickness of the micro-reflecting film 1 formed of the micro-reflecting layer 2 and the transparent substrate 3 ranges between 50 to 100 μm.

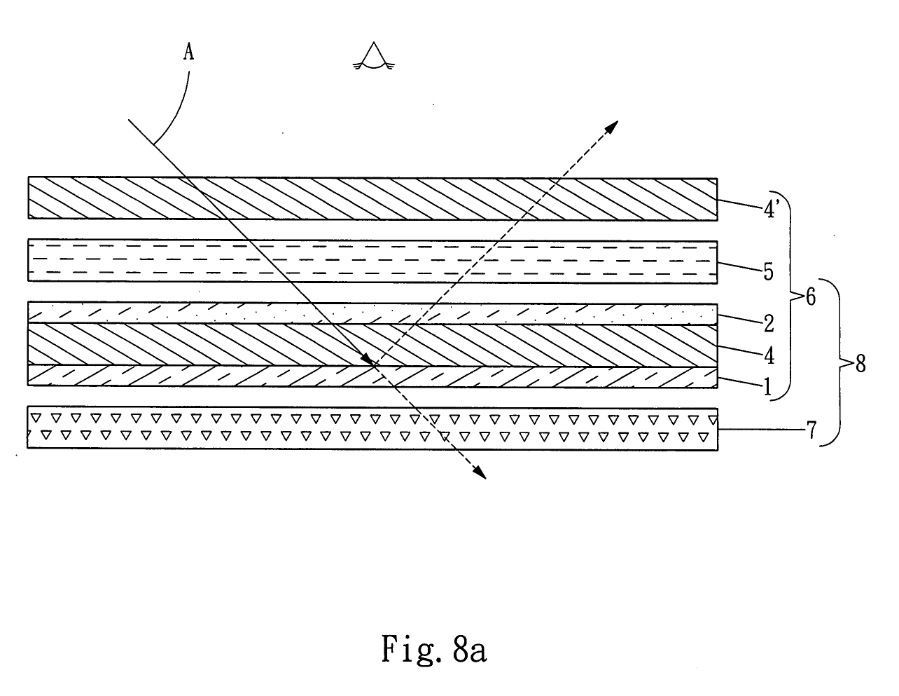

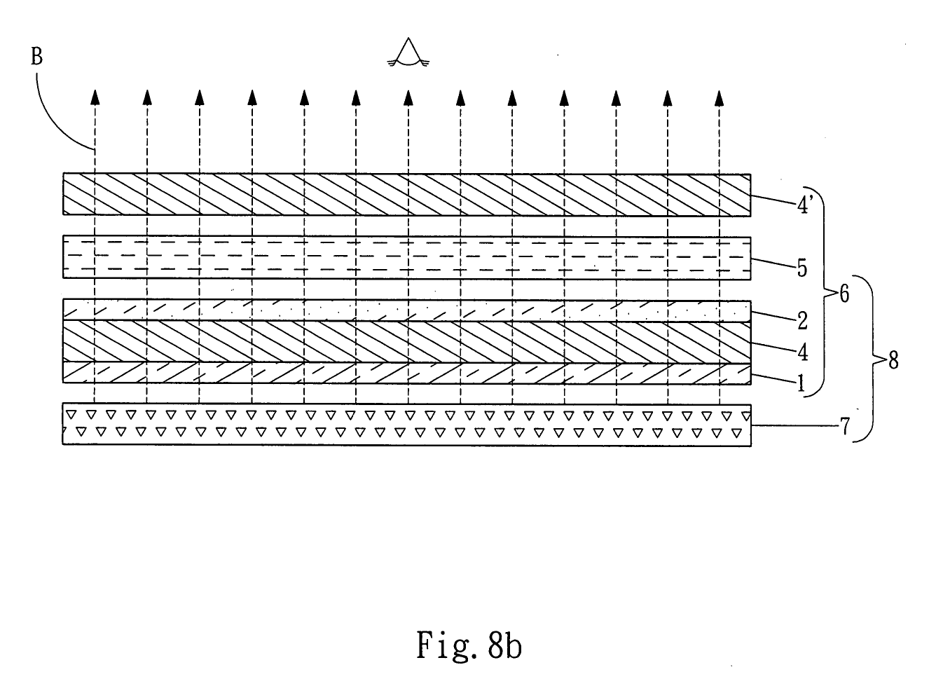

Referring to FIG. 8a and FIG. 8b, FIG. 8a is a schematic view showing the display device using light from an external source to show pictures; and FIG. 8b is a schematic view showing the display device using backlight emitted from the backlight module 7 to show pictures. As shown in FIG. 8b, when the backlight module 7 is driven, the backlight emitted by the backlight module 7 can pass through the lower polarized panel 4, the liquid crystal layer 5 and the upper polarized panel 4′to present images on a screen of the display device. When there is no power provided to the backlight module 7, light from an external source (A) can pass through the upper polarized panel 4′and the liquid crystal layer 5, and then partially pass through the lower polarized panel 4 and partially be reflected back. Thus, the least needed brightness is provided to present simple information, such as time and date, etc.

In summary, the structure of the micro-reflecting layer according to the present invention can be applied to polarized plates and display devices, especially compact and low electricity consumption devices. With the property of light partially-passing and partially-reflected of the micro-reflecting layer, the sufficient brightness is provided by using light form an external source without consuming a lot of power.

With the present invention described, it will be obvious that the same may be varied in many ways. Such variations are not to be regarded as a departure from the sprit and scope of the present invention, and all such modification would be obvious to one skilled in the art are intended to be included within the scope of the following claims.

What is claimed is:

1. A micro-reflecting layer comprising:
a transparent resin layer with a refractive index between 1.3 and 1.6; and
a plurality of micro-reflecting particles with a refractive index between 1.3 and 1.6 and with an average radius of size between 1 μm and 50 μm are distributed inside the transparent resin layer.

2. The micro-reflecting layer according to claim 1, wherein the transparent resin layer comprises acrylic resin.

3. The micro-reflecting layer according to claim 1, wherein the micro-reflecting particles are selected from any of Aluminum oxide (A1₂O₃), Titanium dioxide (TiO₂) and Silicon dioxide (SiO₂).

4. The micro-reflecting layer according to claim 1, wherein the micro-reflecting layer is further attached on a transparent substrate.

5. The micro-reflecting layer according to claim 4, wherein the transparent substrate is selected from any of Polyethylene terephthalate (PET), Triacetyl cellulose (TAC) and Polycarbonate (PC).

6. The micro-reflecting layer for according to claim 1, wherein the weight percentage of the micro-reflecting particles in the micro-reflecting layer is between 1% and 20%.

7. The micro-reflecting layer according to claim 1, wherein a plurality of optical diffusing particles with an average radius of size between 1 μm and 50 μm is implanted into the micro-reflecting layer for diffusing the light in the micro-reflecting layer.

8. The micro-reflecting layer according to claim 7, wherein the optical diffusing particles are selected from any of Titanium dioxide (TiO₂), Silicon dioxide (SiO₂) and silica.

9. The micro-reflecting layer for according to claim 8, wherein the weight percentage of the micro-reflecting particles and optical-diffusing particles in the micro-reflecting layer is between 1% and 20%.

10. The micro-reflecting layer according to claim 8, wherein a transparent substrate is attached to the micro-reflecting layer.

11. The micro-reflecting layer according to claim 10, wherein the transparent substrate is selected from any of polyethylene terephthalate (PET), triacetyl cellulose (TAC) and polycarbonate (PC).

12. A micro-reflecting polarized plate comprising:
a polarized film; and
a micro-reflecting layer comprising a combination of a transparent substrate and a micro-reflecting layer which is attached to the polarized film; wherein the micro-reflecting layer includes:
a transparent resin layer with a refractive index between 1.3 and 1.6;
a plurality of micro-reflecting particles with a refractive index between 1.3 and 1.6 and an average radius of size between 1 and 50 μm distributed in the transparent resin layer; and

13. The micro-reflecting polarized plate according to claim 12, wherein a plurality of optical diffusing particles with an average radius of size between 1 μm and 50 μm is implanted into the micro-reflecting layer for diffusing the light in the micro-reflecting layer.

14. The micro-reflecting polarized plate according to claim 12, further comprising a diffusing adhesive film and an optical brightness enhancement film between the polarized film and the micro-reflecting layer;
wherein the polarized film is attached to one side of the diffusing adhesive film; the optical brightness enhancement film is attached to another side of the diffusing adhesive film; and the micro-reflecting layer is attached to another side of the brightness enhancement film.

15. The micro-reflecting polarized plate according to claim 14, the polarized film comprises a polarized element sandwiched by two protective films; the diffusing adhesive film is mixed with optically diffusible micro-particles and acrylic resin; and the optical brightness enhancement film is formed by multiple layers with different reflective indexes.

16. The micro-reflecting polarized plate according to claim 15, further comprising a second micro-reflecting layer attached to the polarized film, wherein the second micro-reflecting layer is opposite to the micro-reflecting layer and comprises:
a transparent resin layer with a refractive index between 1.3 and 1.6;
a plurality of micro-reflecting particles with a refractive index between 1.3 and 1.6 and an average radius of size between 1 μm and 50 μm distributed in the transparent resin layer.

17. The micro-reflecting polarized plate according to claim 16, wherein a plurality of optical diffusing particles with an average radius of size between 1 μm and 50 μm implanted into the micro-reflecting layer.

18. A display device, comprising:
a backlight module for providing a source of light;
a liquid crystal panel located on one side of the backlight module and comprising a liquid crystal layer and a set of a first polarized plate and a second polarized plate used to clamp the liquid crystal layer;
wherein the second polarized plate comprises least one micro-reflecting layer coated thereon, and the micro-reflecting layer comprises:
a transparent resin layer with a refractive index between 1.3 and 1.6; and
a plurality of micro-reflecting particles with a refractive index between 1.3 and 1.6 and an average radius of size between 1 μm to 50 μm implanted into the transparent resin.

19. The display device according to claim 18, wherein the weight percentage of the micro-reflecting particles in the micro-reflecting layer is between 1% and 20%.

20. The display device according to claim 18, wherein a plurality of optical diffusing particles is implanted into the micro-reflecting layer for uniformly diffusing light in the micro-reflecting layer.
